(19) United States
(12) Patent Application Publication
(10) Pub. No.: US 2025/0091822 A1
(43) Pub. Date: Mar. 20, 2025

(54) CONVEYOR SUBSYSTEM FOR HANDLING UNCONVEYABLE PARCELS AND PARCEL TRANSFER SYSTEM INCLUDING SAME

(71) Applicant: Material Handling Systems, Inc., Mt. Washington, KY (US)

(72) Inventors: Paul Receveur, New Albany, IN (US); Thomas Anthony Hillerich, JR., Louisville, KY (US); Madhav Devidas Patil, Louisville, KY (US)

(21) Appl. No.: 18/829,770

(22) Filed: Sep. 10, 2024

Related U.S. Application Data
(60) Provisional application No. 63/582,886, filed on Sep. 15, 2023.

(51) Int. Cl. B65G 67/02; B65G 15/00; B65G 43/08; B65G 47/90

(52) U.S. Cl. CPC B65G 67/02; B65G 43/08; B65G 47/90; B65G 15/00; B65G 2203/041

(57) ABSTRACT

A parcel transfer system for loading parcels into a cargo area of a transport vehicle includes: one or more robots for transferring parcels from the parcel transfer system to the cargo area; a conveyor subsystem for handling parcels for potential loading in the cargo area; and a control subsystem operably connected to, and configured to affect the operation of, one or more components of the conveyor subsystem. The conveyor subsystem includes a feed conveyor and a rejection apparatus. The feed conveyor conveys a flow of parcels towards the one or more robots and selectively directs unconveyable parcels off the feed conveyor. The rejection apparatus is positioned to receive unconveyable parcels directed off of the feed conveyor and subsequently transports the received unconveyable parcels in a desired manner. The rejection apparatus can be in the form of a rejection conveyor or a self-driving vehicle.

### CROSS-REFERENCE TO RELATED APPLICATION

The present application claims priority to U.S. Patent Application Ser. No. 63/582,886 filed on Sep. 15, 2023, the entire disclosure of which is incorporated herein by reference.

### BACKGROUND OF THE INVENTION

The presently disclosed subject matter relates to conveyor systems and parcel transfer systems which can be utilized in parcel transfer applications, such as loading parcels into a transport vehicle.

In commercial shipping, loading bays are used to facilitate the loading of parcels from a shipping facility into the cargo area of a transport vehicle (e.g., the trailer portion of a tractor-trailer) and/or the unloading of parcels from the cargo area of the transport vehicle into the shipping facility. In this regard, a loading bay typically corresponds to an entryway defined in the side of a building to which the cargo area of a transport vehicle can be brought in close proximity. For instance, in many loading applications, the trailer portion of a tractor-trailer is backed toward a loading bay until the trailer portion of the tractor-trailer engages one or more bumpers positioned on the exterior of the loading bay, thereby creating a slight gap between the loading bay and the trailer portion of the tractor-trailer, which is subsequently bridged (e.g., via a dock leveler or dock plate). Traditionally, manual labor has been employed to place parcels in the cargo area of transport vehicles. The reliance on manual labor for such loading applications not only increases operational costs, but also can increase the risk of injury to workers charged with manually loading and unloading parcels.

Various systems have been developed to assist in loading parcels, which include, for example, a conveyor and a robotic arm for transferring parcels from the conveyor to designated locations within the cargo area of a transport vehicle. Parcels with shape, size, and/or weight characteristics which render it more difficult (as compared to other parcels with different characteristics) or impossible for the robotic arm to transfer such parcels (or “unconveyable” parcels) are, however, commonly and indiscriminately loaded onto the conveyor, which can significantly impede the parcel transfer rate of the system. Accordingly, when unconveyable parcels reach the robotic arm, such parcels must be addressed before the normal operation and/or transfer rate of the system can be restored. Traditionally, unconveyable parcels have been addressed by manual intervention.

Accordingly, conveyor systems which handle unconveyable parcels affecting parcel transfer rate and parcel transfer systems including the same would be both beneficial and desirable.

### SUMMARY OF THE INVENTION

The present disclosure relates to a parcel transfer system for loading parcels into a cargo area of a transport vehicle, which includes a conveyor system for handling unconveyable parcels that can impede parcel transfer rates. As the conveyor system is a component of the parcel transfer system, the conveyor system may also be characterized as a “conveyor subsystem” for handling unconveyable parcels.

A parcel transfer system for loading parcels into a cargo area of a transport vehicle includes: one or more robots for transferring parcels from the parcel transfer system to the cargo area of the transport vehicle; a conveyor subsystem for handling parcels for potential loading in the cargo area; and a control subsystem operably connected to, and configured to affect the operation of, one or more components of the conveyor subsystem.

A conveyor subsystem made in accordance with the present disclosure generally includes: a feed conveyor configured; and a rejection apparatus. The feed conveyor is configured to convey a flow of parcels toward the one or more robots and selectively direct select parcels from the flow of parcels off of the feed conveyor. The rejection apparatus is positioned to receive the select parcels directed off of the feed conveyor. The select parcels directed off of the feed conveyor can correspond to parcels which exhibit one or more characteristics which render the parcels incapable of being transferred by the one or more robots or being transferred as quickly as other parcels in the flow of parcels. These select parcels can thus also be characterized as “unconveyable” parcels. Unconveyable parcels received by the rejection apparatus are subsequently transported by the rejection apparatus in a desired manner, which, in various embodiments and implementations, can include directing the unconveyable parcels off of the rejection apparatus (e.g., out of the conveyor subsystem or back onto the feed conveyor for another attempt to be transferred by the one or more robots) or transporting the unconveyable parcels to an intended destination, either in or outside of the cargo area.

In some embodiments, the feed conveyor includes multiple conveyors.

In some embodiments, the feed conveyor includes a first conveyor and a second conveyor. The first conveyor of the feed conveyor is configured to convey the flow of parcels in at least a first direction along a longitudinal axis of the feed conveyor toward the one or more robots.

In some embodiments, the second conveyor of the feed conveyor is positioned downstream of the first conveyor and is configured to convey the flow of parcels in the first direction toward the one or more robots.

In some embodiments, the second conveyor is configured to convey the unconveyable parcels in a second direction that is transverse to the longitudinal axis of the feed conveyor to direct the unconveyable parcels off of the feed conveyor.

In some embodiments, the second conveyor of the feed conveyor includes a repositionable surface configured to transition between a first configuration and a second configuration to direct the unconveyable parcels off of the feed conveyor. In some embodiments, the first configuration corresponds to the repositionable surface being in one of a raised or lowered configuration, and the second configuration corresponds to the repositionable surface being in the other of the raised or lowered configuration.

In some embodiments, the feed conveyor includes a third conveyor that is positioned between the first conveyor and the second conveyor and is configured to selectively convey parcels from the flow of parcels towards the second conveyor or the rejection apparatus.

In some embodiments, the rejection apparatus is in the form of a rejection conveyor that is positioned to receive unconveyable parcels directed off of the feed conveyor.

In some embodiments, the rejection conveyor is configured to direct unconveyable parcels off of the rejection conveyor.

In some embodiments, the rejection conveyor includes a multi-directional conveyor that is configured to convey unconveyable parcels in a first direction along a longitudinal axis of the rejection conveyor and selectively convey unconveyable parcels in a second direction transverse to the longitudinal axis of the rejection conveyor to direct unconveyable parcels off of the rejection conveyor.

In some embodiments, the rejection conveyor includes multiple conveyors.

In some embodiments, the rejection conveyor includes a first conveyor and a second conveyor. The first conveyor of the rejection conveyor is positioned to receive unconveyable parcels directed off of the feed conveyor, and is configured to convey the unconveyable parcels in first direction along the longitudinal axis of the rejection conveyor.

In some embodiments, the second conveyor of the rejection conveyor is configured to direct unconveyable parcels off of the second conveyor in multiple directions.

In some embodiments, the rejection conveyor includes a third conveyor that is configured to selectively direct unconveyable parcels received from the second conveyor of the rejection conveyor either back onto the second conveyor of the rejection conveyor or off of the rejection conveyor.

In some embodiments, the rejection apparatus is in the form of a self-driving vehicle (“SDV”) that is positioned to receive unconveyable parcels directed off of the feed conveyor. Unconveyable parcels received by the SDV can be subsequently transported by the SDV to an intended destination, either in or out of the cargo area.

The control subsystem of the parcel transfer system includes: one or more sensors for acquiring data corresponding to one or more characteristics of parcels in the flow of parcels on the feed conveyor; and a controller that receives and processes the data from the one or more sensors. The data acquired from the one or more sensors can be utilized by the controller to identify which parcels in the flow of parcels on the feed conveyor are unconveyable.

In some embodiments, the feed conveyor is operably connected to the control subsystem, such that the controller can communicate instructions which cause the feed conveyor to direct unconveyable parcels from the flow of parcels off of the feed conveyor based on the data acquired by the one or more sensors.

In some embodiments, the one or more robots are operably connected to the control subsystem, such that the controller can communicate instructions which cause the one or more robots to transfer parcels from the flow of parcels from the conveyor subsystem to the cargo area of the transport vehicle based on the data acquired by the one or more sensors.

In some embodiments, the rejection conveyor is operably connected to the control subsystem, such that the controller can communicate instructions which cause the rejection conveyor to convey unconveyable parcels to the feed conveyor or out of the conveyor subsystem.

In some embodiments, the SDV is operably connected to the control subsystem, such that the controller can communicate instructions which cause the SDV to transport unconveyable parcels loaded thereon.

### BRIEF DESCRIPTION OF THE DRAWINGS

FIG. 1 is a schematic view of a parcel transfer system, including an exemplary conveyor system for handling unconveyable parcels made in accordance with the present disclosure;

FIG. 2 is a schematic view of another parcel transfer system, including another exemplary conveyor system for handling unconveyable parcels made in accordance with the present disclosure;

FIG. 3 is a schematic view of another parcel transfer system, including another exemplary conveyor system for handling unconveyable parcels made in accordance with the present disclosure;

FIG. 4 is a schematic view of another parcel transfer system, including another exemplary conveyor system for handling unconveyable parcels made in accordance with the present disclosure;

FIG. 5A is a schematic view of another parcel transfer system, including another exemplary conveyor system for handling unconveyable parcels made in accordance with the present disclosure, with a second conveyor of a feed conveyor of the exemplary conveyor system in a first configuration;

FIG. 5B is another schematic view of the parcel transfer system of FIG. 5A, but with the second conveyor of the feed conveyor of the exemplary conveyor system in a second configuration;

FIG. 6A is a schematic view of another parcel transfer system, including another exemplary conveyor system for handling unconveyable parcels made in accordance with the present disclosure, with a second conveyor of a feed conveyor of the exemplary conveyor system in a first configuration;

FIG. 6B is another schematic view of the parcel transfer system of FIG. 6A, but with the second conveyor of the feed conveyor of the exemplary conveyor system in a second configuration;

FIG. 7A is a schematic view of another parcel transfer system, including another exemplary conveyor system for handling unconveyable parcels made in accordance with the present disclosure, with a second conveyor of a feed conveyor of the exemplary conveyor system in a first configuration;

FIG. 7B is another schematic view of the parcel transfer system of FIG. 7A, but with the second conveyor of the feed conveyor of the exemplary conveyor system in a second configuration;

FIG. 8 is a schematic view of another parcel transfer system, including another exemplary conveyor system for handling unconveyable parcels made in accordance with the present disclosure;

FIG. 9 is a schematic view of another parcel transfer system, including another exemplary conveyor system for handling unconveyable parcels made in accordance with the present disclosure; and

FIG. 10 is a schematic diagram of a control subsystem which may be utilized in the parcel transfer systems of FIGS. 1-4, 5A, 5B, 6A, 6B, 7A, 7B, 8, and 9.

### DESCRIPTION OF THE INVENTION

The present disclosure includes conveyor systems for handling unconveyable parcels that can impede transfer rates, along parcel transfer systems including such a conveyor system (or subsystem) which can be utilized in parcel transfer applications, such as loading parcels into a transport vehicle.

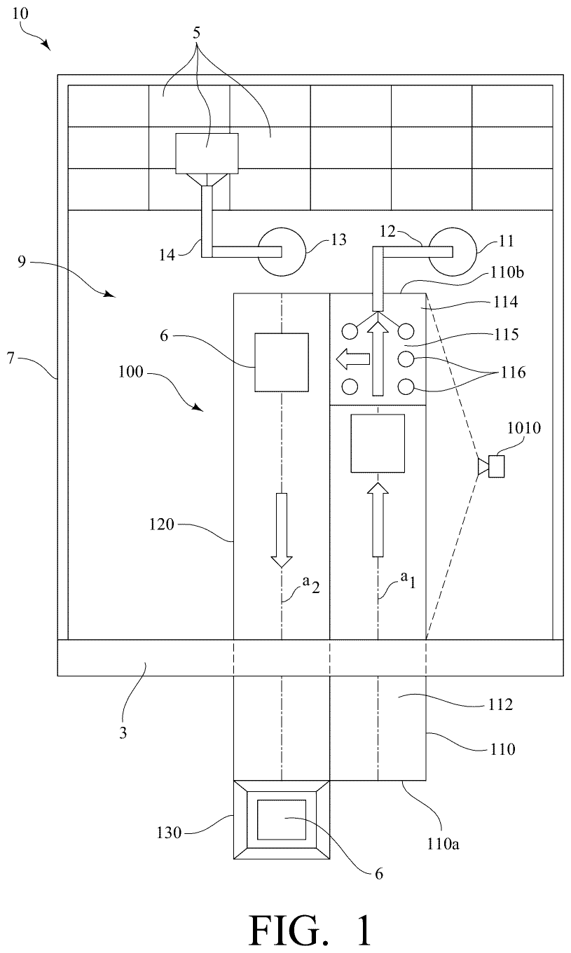

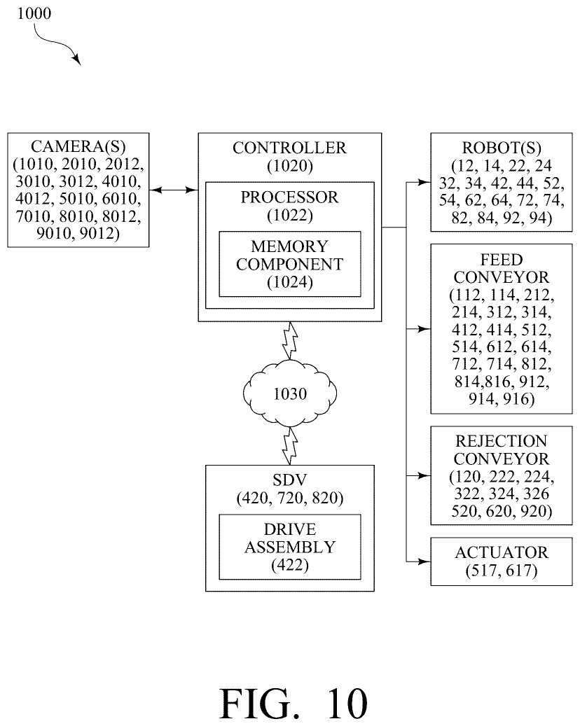

Referring first to FIGS. 1 and 10, a parcel transfer system 10 includes: an exemplary conveyor system 100 made in accordance with the present disclosure; one or more robots 12, 14; and a control subsystem 1000 that is configured to identify unconveyable parcels and is operably connected to the conveyor system 100 and the one or more robots 12, 14, such that the control subsystem 1000 can communicate instructions to affect certain operations of the conveyor system 100 and the one or more robots 12, 14. The one or more robots 12, 14 are positioned and configured to transfer parcels conveyed by the conveyor system 100 off of the conveyor system 100 to a designated location, which, in this implementation, is a cargo area 9 of a transport vehicle. Parcels suitable for transfer by the one or more robots 12, 14 can also be characterized as “conveyable” parcels. Conveyable parcels are indicated with reference numeral “5” throughout the present disclosure. Parcels identified by the control subsystem 1000 as being unconveyable (or “unconveyable” parcels) are processed by the conveyor system 100 in a manner which, at least temporarily, removes the unconveyable parcels as potential candidates for transfer by the one or more robots 12, 14. Unconveyable parcels are indicated with reference numeral “6” throughout the present disclosure. With the unconveyable parcels 6 removed as potential candidates for transfer, the one or more robots 12, 14 do not waste time attempting to transfer parcels which either cannot be transferred by the one or more robots 12, 14 or which cannot be transferred as quickly as other conveyable parcels 5 on the conveyor system 100, thus reducing the extent to which the parcel transfer rate by the one or more robots 12, 14 is affected.

As the various conveyor systems 100, 200, 300, 400, 500, 600, 700, 800, 900 disclosed herein are utilized as a component of the various parcel transfer systems 10, 20, 30, 40, 50, 60, 70, 80, 90 disclosed herein, each respective conveyor system 100, 200, 300, 400, 500, 600, 700, 800, 900 can also be characterized as a “conveyor subsystem.”

It is appreciated that the term “unconveyable” parcel as used herein refers to a parcel having a characteristic or multiple characteristics which correspond to predefined criteria programmed into the control subsystem 1000 of the various parcel transfer systems disclosed herein. In some embodiments, such predefined criteria may correspond to: parcel spatial dimensions, parcel shape, parcel weight, and/or other parcel characteristics which render it either impossible or more difficult (as compared to other parcels) for the one or more robots of the parcel transfer systems to transfer; and/or parcel spatial dimensions, parcel shape, parcel weight, and/or other parcel characteristics which make it undesirable for the one or more robots to transfer at a particular time. In some cases, a parcel may have suitable physical characteristics, but still may be “unconveyable” because it cannot be effectively engaged by the end effector.

Unless otherwise indicated, reference to a “bidirectional conveyor” means a conveyor which can be driven in a fore and aft direction, and reference to a “multi-directional conveyor” means a conveyor which can be selectively driven in a first direction and a second direction that is transverse to or different from the first direction. In some embodiments, a multi-directional conveyor may be configured to be driven in a first direction, a second direction which is opposite of the first direction, and a third direction which is transverse to the first direction and the second direction.

It is also important to recognize that, in the discussion that follows and in the claims of the present application, the term “parcel” is not intended to be limiting and can include any article, item, or object that may be transported, loaded, and/or unloaded in the manner specified within the present disclosure.

Referring now specifically to FIG. 1, in this implementation, the cargo area 9 is defined by a trailer portion 7 of a semi-truck that is configured to be pulled by the tractor portion (not shown) of the semi-truck. To better illustrate the positioning of the conveyor system 100 and the one or more robots 12, 14 within the cargo area 9, the top of the trailer portion 7 of the semi-truck has been removed in the drawings. Of course, it is appreciated that the conveyor subsystems and/or the parcel transfer systems disclosed herein may be utilized to load parcels 5 into the cargo area of other transport vehicles, such as vans, box trucks, train cars, etc., without departing from the spirit and scope of the present invention.

Referring still to FIG. 1, in this exemplary embodiment, the parcel transfer system 10 includes two robots: a first robot 12 and a second robot 14, with each robot 12, 14 positioned and configured to engage and transfer parcels from a distal end of the conveyor subsystem 100 to the cargo area 9, for example, in a stacked configuration. Specifically, in this exemplary embodiment, each robot 12, 14 is in the form of a robotic arm. One suitable robot which can be used as the first robot 12 and the second robot 14 is the M-1000iD/35 robot manufactured by and available from FANUC America of Rochester Hills, Michigan. As shown, in this exemplary embodiment, the first robot 12 and the second robot 14 are mounted to a first pedestal 11 and a second pedestal 13, respectively, which are positioned within the cargo area 9. In transport vehicle loading applications, the distal end of the conveyor subsystem 100, the first robot 12, and the second robot 14 will typically be initially placed in a central position of the cargo area 9 farthest from a loading bay 3 to maximize the amount of parcels that can be loaded into the cargo area 9. As one portion of the cargo area 9 (e.g., an area immediately adjacent to the back wall) becomes filled with parcels 5 placed by the first robot 12 and the second robot 14, the distal end of the conveyor subsystem 100, the first robot 12, and the second robot 14 are moved rearwardly toward the loading bay 3, so that additional parcels can be placed in a new, unfilled area of the cargo area 9. The above-described process can be repeated until the cargo area 9 is completely filled with parcels or all parcels intended for transport have been loaded into the cargo area 9.

To facilitate repositioning of the first robot 12 and the second robot 14 within the cargo area 9, in some embodiments, the first pedestal 11 and the second pedestal 13 may be provided with wheels (or rollers). In alternative embodiments, instead of being mounted to the first pedestal 11 and the second pedestal 13, the first robot 12 and the second robot 14 form part of a mobile robot assembly. In such embodiments, each mobile robot assembly may include: a base, a robot (such as the first robot 12 or the second robot 14) mounted to the base; and a drive assembly that is mounted to the base and includes a plurality of wheels (or rollers) that can be driven to move the robot assembly within the cargo area 9. In some embodiments, the drive subassembly of the mobile robot assembly may include one or more components of, and may be driven by a motor control subsystem in a manner similar to, the self-driving vehicle (SDV) disclosed in commonly assigned U.S. Pat. No. 11,897,702, which is incorporated herein by reference.

For improved parcel throughput and transfer rates within the parcel transfer system 10, the use of multiple robots is generally preferred to reduce the effects of cycle time limitations (i.e., the time required for each iterative transfer of a parcel from the conveyor subsystem 100 to the cargo area 9), for example, by having one robot pick a parcel 5 from the conveyor subsystem 100 while another robot is actively transferring another parcel 5 to a designated location within the cargo area. In this regard, the first robot 12 and the second robot 14 may be moved, for example, in response to instructions communicated by the control subsystem 1000, in a manner similar to or consistent with the various movement cycles and/or routines disclosed in commonly assigned U.S. Pat. Nos. 11,753,256 and 12,059,803, each of which is incorporated herein by reference.

Referring still to FIG. 1, in this exemplary embodiment, the conveyor subsystem 100 includes: a feed conveyor 110; and a rejection conveyor 120, which, in this implementation, each extend through the loading bay 3 and into the cargo area 9 of the transport vehicle. The feed conveyor 110 is configured to convey parcels loaded onto a proximal end 110a of the feed conveyor 110 toward a distal end 110b of the feed conveyor 110 and into an area of the feed conveyor 110 from which the first robot 12 and the second robot 14 engage and transfer parcels 5 (i.e., a “pick area” of the feed conveyor 110). In other words, the feed conveyor 110 is configured to convey parcels loaded onto the feed conveyor 110 in a direction of travel, which, in this exemplary embodiment, is a forward direction along a longitudinal axis, a₁, of the feed conveyor toward the first robot 12 and the second robot 14. In addition to conveying parcels to the pick area of the feed conveyor 110, in this exemplary embodiment, the feed conveyor 110 is also configured to selectively direct unconveyable parcels 6 off of the feed conveyor 110, thus leaving only conveyable parcels 5 within the pick area and/or making additional room within the pick area for conveyable parcels 5 located upstream of the pick area. The rejection conveyor 120 is positioned to receive the unconveyable parcels 6 offloaded from the feed conveyor 110. Specifically, in this exemplary embodiment, the rejection conveyor 120 is positioned beside the feed conveyor 110, such that the longitudinal axis, a₁, of the feed conveyor 110 and the longitudinal axis, a₂, of the rejection conveyor 120 are parallel to each other. As shown, in this exemplary embodiment, the rejection conveyor 120 is positioned directly beside the feed conveyor 110 so that parcels directed off of the side of the feed conveyor 110 to which the rejection conveyor 120 is adjacent are immediately deposited onto the rejection conveyor 120. The positioning of the feed conveyor 110 and the rejection conveyor 120 so that their longitudinal axes are parallel, along with the feed conveyor 110 and the rejection conveyor 120 being positioned directly beside each other, aids the conveyor subsystem 100 in fitting within the spatial confines of the cargo area of transport vehicles. It is appreciated, however, that alternative embodiments in which the feed conveyor 110 and the rejection conveyor 120 are positioned adjacent or near each other, but not directly beside each other, are also contemplated herein. For instance, in some alternative embodiments, one or more intermediate or “buffering” conveyors may be placed between the feed conveyor 110 and the rejection conveyor 120, where the one or more intermediate conveyors are configured to regulate the rate at which parcels offloaded by the feed conveyor 110 are transferred to the rejection conveyor 120. It is further appreciated that alternative embodiments in which the axes of the feed conveyor 110 and the rejection conveyor 120 are not parallel relative to each other are also contemplated herein.

Referring still to FIG. 1, the rejection conveyor 120 is configured to direct received unconveyable parcels 6 off of the rejection conveyor 120. Specifically, in this exemplary embodiment and implementation, unconveyable parcels 6 directed onto the rejection conveyor 120 can be subsequently driven by operation of the rejection conveyor 120 out of the cargo area 9 and through the loading bay 3, until ultimately directed off of an end of the rejection conveyor 120 and into a bin 130 positioned by the end of the rejection conveyor 120. Parcels offloaded into the bin 130 can be subsequently loaded into the cargo area 9 manually, or, in instances where a parcel is capable of being transferred by the first robot 12 or the second robot 14, provided back onto the feed conveyor 110 for another attempt to be transferred by the first robot 12 or the second robot 14. Thus, in some implementations, a parcel initially identified as unconveyable may later be identified as conveyable (i.e., eligible for transfer by the first robot 12 and the second robot 14 at a subsequent time), for example, when the number of parcels on the feed conveyor 110 is reduced or after parcels of predetermined dimensional and/or weight characteristics have been transferred by the first robot 12 and the second robot 14. Parcels directed off the rejection conveyor 120 and into the bin 130 are considered to have been conveyed out of the conveyor subsystem 100.

Furthermore, and referring still to FIG. 1, it is also contemplated that, in some embodiments, the robots 12, 14 may also pick from parcels that have been offloaded onto the rejection conveyor 120. In this regard, in some cases, once a particular parcel has been offloaded onto the rejection conveyor 120, the control subsystem 1000 may be better able to detect and/or one of the robots 12, 14 may be better able to engage the particular parcel (relative to when the particular parcel was located in the pick area of the feed conveyor 110) as a result of the particular parcel being isolated and moved away from other parcels on the feed conveyor 110. Accordingly, in some embodiments, the rejection conveyor 120 may also provide an area from which the first robot 12 and the second robot 14 can engage and transfer parcels 5 from (i.e., a “pick area”). In cases where a particular parcel is intended to be picked by one of the robots 12, 14, the conveying surface of the rejection conveyor 120 corresponding to the pick area will remain stationary for a predetermined period of time or until removal of the particular parcel is detected by the control subsystem 1000 to enable the first robot 12 or the second robot 14 to engage and transfer such parcel.

Returning to the definition of “unconveyable,” in some implementations, the criteria defining which parcels will be identified by the control subsystem 1000 as being “unconveyable” may be initially set and subsequently adjusted to maximize the number of parcels that can be loaded into the cargo area 9 and/or dictate the types of parcels loaded into the cargo area 9 at a given time. For instance, in some implementations, the criteria for unconveyable parcels may be initially set so that only parcels of a specific dimension or falling within a specific range of dimensions are eligible for transfer by the first robot 12 and the second robot 14. Then, once all parcels satisfying such criteria have been transferred to the cargo area 9, the criteria for unconveyable parcels can be adjusted so that parcels of another dimension or falling within another range of dimensions, which at the time the initial criteria was set would have disrupted, for example, efficient stacking of the parcels, are eligible for transfer. In other implementations, the criteria for unconveyable parcels may be set and subsequently adjusted so that heavier parcels are loaded into cargo area 9 before lighter parcels to prevent lighter parcels from being crushed by the heavier parcels when the transport vehicle brakes. It is thus appreciated that, in some embodiments, the criteria as to which parcels will be deemed and treated as unconveyable may change during the course of operation of the parcel transfer systems disclosed herein.

Referring still to FIG. 1, in this exemplary embodiment, the rejection conveyor 120 is defined by only a single conveyor, while the feed conveyor 110 actually includes two separate conveyors: a first conveyor 112, which defines the proximal end 110a of the feed conveyor 110; and a second conveyor 114 that is positioned to receive parcels offloaded from the first conveyor 112 and defines the distal end 110b and pick area of the feed conveyor 110. As will become evident in the discussion that follows, rejection conveyors which are defined by multiple conveyors can also be utilized. As shown, in this exemplary embodiment, the second conveyor 114 is positioned relative to the first conveyor 112 of the feed conveyor 110 so that parcels directed off of a distal end of the first conveyor 112 are immediately deposited onto the second conveyor 114. Alternative embodiments are, however, contemplated in which one or more intermediate or “buffering” conveyors are placed between the first conveyor 112 and the second conveyor 114 of the feed conveyor 110 and are configured to regulate the rate at which parcels offloaded by the first conveyor 112 are transferred to the second conveyor 114 of the feed conveyor 110. It should thus be appreciated that, where reference is made to two conveyors in the various conveyor subsystem embodiments disclosed herein being positioned relative to each other such that parcels directed off of one of the two conveyors are received by the other of the two conveyors, such reference does not preclude the possibility of one or more intermediate conveyors configured to convey parcels being provided between the two conveyors to facilitate transfer of parcels from one of the two conveyors to the other of the two conveyors. I

Referring still to FIG. 1, in this exemplary embodiment, both the first conveyor 112 and the rejection conveyor 120 are unidirectional belt conveyors. However, to facilitate the offloading of unconveyable parcels 6 onto the rejection conveyor 120, the second conveyor 114 of the feed conveyor 110 is a multi-directional conveyor that can be activated to: (i) convey parcels in a forward direction along the longitudinal axis, a₁, of the feed conveyor 110 toward the distal end 110b of the feed conveyor 110, and thus the first robot 12 and the second robot 14; and (ii) convey parcels in a direction transverse to the longitudinal axis, a₁, of the feed conveyor 110, the importance of which is further described below. In this exemplary embodiment, the second conveyor 114 is an activated roller belt including a belt 115 and rollers 116 (which can also be in the form of or characterized as balls) integrated within the belt 115. The belt 115 is configured to be driven in the forward direction to advance parcels loaded onto the second conveyor 114 closer to the distal end 110b of the feed conveyor 110. The rollers 116 can be selectively activated while an unconveyable parcel 6 is on the second conveyor 114 of the feed conveyor 110 to move the unconveyable parcel 6 from the second conveyor 114 transverse to the longitudinal axis, a₁, of the feed conveyor 110 and onto the rejection conveyor 120. Activated roller belts which may be utilized for the second conveyor 114 of the feed conveyor 110 include those described in U.S. Pat. No. 11,897,702 and U.S. Patent Application Publication No. 2023/0271791, each of which is commonly assigned and incorporated herein by reference. The respective conveyors of the feed conveyor 110 may also be characterized as “modules” of the feed conveyor 110. While the use of a multi-directional conveyor is generally preferred for the second conveyor 114 of the feed conveyor 112 to facilitate repositioning of parcels provided thereon relative to the first robot 12 and the second robot 14, alternative embodiments in which the second conveyor 114 of the feed conveyor 112 is a unidirectional conveyor that is oriented such that, when activated, conveys parcels loaded thereon in a direction transverse to the longitudinal axis, a₁, of the feed conveyor 110 are also contemplated herein.

Referring again to FIGS. 1 and 10, as noted above, the control subsystem 1000 is configured to identify parcels on the feed conveyor 110 which are “unconveyable” based on input data corresponding to parcels on the feed conveyor 110. In this regard, the control subsystem 1000 thus includes one or more sensors for acquiring data corresponding to one or more characteristics of parcels located on the feed conveyor 110, which is subsequently used by the control subsystem 1000 to identify unconveyable parcels. Subsequent to identifying a parcel as unconveyable, the control subsystem 1000 communicates instructions to the second conveyor 114 of the feed conveyor 110 to activate the rollers 116 and direct the unconveyable parcel 6 onto rejection conveyor 120.

Referring still to FIGS. 1 and 10, in this exemplary embodiment, the control subsystem 1000 is configured to identify unconveyable parcels 6 located on the feed conveyor 110 and subsequently communicate instructions (signals) to the second conveyor 114 based on images of parcels on the feed conveyor 110. Accordingly, in this exemplary embodiment, the control subsystem 1000 can also be characterized as a “vision and control subsystem.” As best shown in FIG. 10, in this exemplary embodiment, the one or more sensors of the control subsystem 1000 includes a camera 1010. The control subsystem 1000 further includes a controller 1020 that is, in this exemplary embodiment, operably connected to the camera 1010, such that the controller 1020 can communicate instructions to and receive data from the camera 1010. As best shown in FIG. 1, the camera 1010 can be positioned so that the field of view of the camera 1010 encompasses at least the portion of the feed conveyor 110 located immediately upstream of the pick area of the feed conveyor 110 to ensure the control subsystem 1000 has sufficient time to identify unconveyable parcels 6 prior to them being received in the pick area of the feed conveyor 110. In instances where parcels are loaded onto the feed conveyor 110 in a singulated flow in which the parcels are positioned at substantially equal intervals and aligned (i.e., in a single file line), positioning the camera 1010 in this manner may aid in ensuring that the control subsystem 1000 has sufficient time to (i) identify unconveyable parcels 6 prior to being received in the pick area of the feed conveyor 110, and (ii) communicate instructions to the second conveyor 114 so that the unconveyable parcel 6 is immediately offloaded onto the rejection conveyor 120 upon entry into the pick area of the feed conveyor 110. However, embodiments in which the field of view of the camera 1010 encompasses only the pick area of the feed conveyor 110, the full length of the first conveyor 112 positioned within the cargo area 9, some or all of the second conveyor 114, and/or some or all of the rejection conveyor 120 are also contemplated herein. For instance, where parcels will typically be loaded onto the feed conveyor 110 in a bulk flow (i.e., where the parcels are not in a single file line and/or spaced apart from each other a predetermined distance, and where multiple parcels may be present in the pick area of the feed conveyor 110 at a given time, the camera 1010 may be positioned with the pick area of the feed conveyor 110 within its field of view so that the control subsystem 1000 can identify which parcels within the pick area of the feed conveyor should be transferred to the cargo area 9 prior to the rollers 116 of the second conveyor 114 being activated to offload unconveyable parcels 6 received in the pick area of the feed conveyor 110.

Referring still to FIGS. 1 and 10, the camera 1010 is configured to acquire two-dimensional and/or three-dimensional images. Suitable cameras which may be utilized as the camera 1010 include the image sensors manufactured and distributed by ifm Effector Inc. of Malvern, Pennsylvania. In this exemplary embodiment, the camera 1010 is configured to obtain images substantially continuously. Alternative embodiments are contemplated, however, in which the camera 1010 is selectively activated to obtain images of the pick area in response to instructions (or signals) communicated from the controller 1020. Although the camera 1010 is generally referred to herein and illustrated within the drawings as including only a single camera, embodiments in which the camera 1010 comprises multiple cameras configured to capture images that are subsequently communicated to and processed by the controller 1020 are also contemplated herein. In this exemplary embodiment, images acquired by the camera 1010 are transmitted to the controller 1020 as image data for subsequent processing. In alternative embodiments, however, the images acquired by the camera 1010 may be processed locally by a vision unit of which the camera 1010 is a component, with the processed images then being transmitted to the controller 1020 as image data for subsequent processing. In such embodiments, the vision unit will typically further include a processor (not shown) configured to execute instructions (routines) stored in a memory component (not shown) or other computer-readable medium to process the images acquired by the camera 1010. Suitable processors for use in the vision unit in such embodiments include that provided within the Jetson Nano computer manufactured and distributed by Nvidia Corporation of Santa Clara, California. Of course, other processors suitable for locally processing the images acquired by the camera 1010 may also be used.

Referring now specifically to FIG. 10, the controller 1020 includes a processor 1022 configured to execute instructions stored in a memory component 1024 or other computer-readable medium to perform the various operations of the controller 1020 described herein. It should be appreciated that, aside from the operations characterized herein as being performed by the one or more sensors of the control subsystem 1000, the operations indicated herein as being performed by the control subsystem 1000 are performed by the controller 1020 unless otherwise stated or context precludes. In this exemplary embodiment, the controller 1020 is a programmable logic controller or other industrial controller. The controller 1020 is connected to the camera 1010 to facilitate the transmission of data from the camera 1010 to the controller 1020 either by wired connection (e.g., Ethernet connection) or by wireless connection (e.g., via a network) using known interfaces and protocols. As shown, in this exemplary embodiment, the controller 1020 is also operably connected to the first conveyor 112 of the feed conveyor 110, the first robot 12, the second robot 14, and the rejection conveyor 120. Accordingly, in some implementations, the image data received by the controller 1020 may be utilized to regulate certain operations of the first conveyor 112 of the feed conveyor 110, the first robot 12, the second robot 14, and/or the rejection conveyor 120. For instance, the controller 1020 may communicate instructions based on received image data which: selectively index the first conveyor 112; selectively activate the rejection conveyor 120; identify, in instances where multiple parcels are simultaneously provided within the pick area of the feed conveyor 110, which of the multiple parcels should be transferred next; and/or dictate which of the first robot 12 and the second robot 14 is used to transfer a parcel from the pick area at a given time. In embodiments, in which one or more intermediate conveyors are positioned between the first conveyor 112 and the second conveyor 114 of the feed conveyor 110, the controller 1020 may further be operably connected to some or all of the one or more immediate conveyors to communicate instructions to affect the operation thereof and regulate the rate at which parcels are transferred from the first conveyor 112 to the second conveyor 114 of the feed conveyor 110. The criteria or multiple sets of criteria as to which parcels should be identified as “unconveyable” at a particular time can be pre-programmed in the controller 1020 (i.e., embodied within the instructions stored in the memory component 1024).

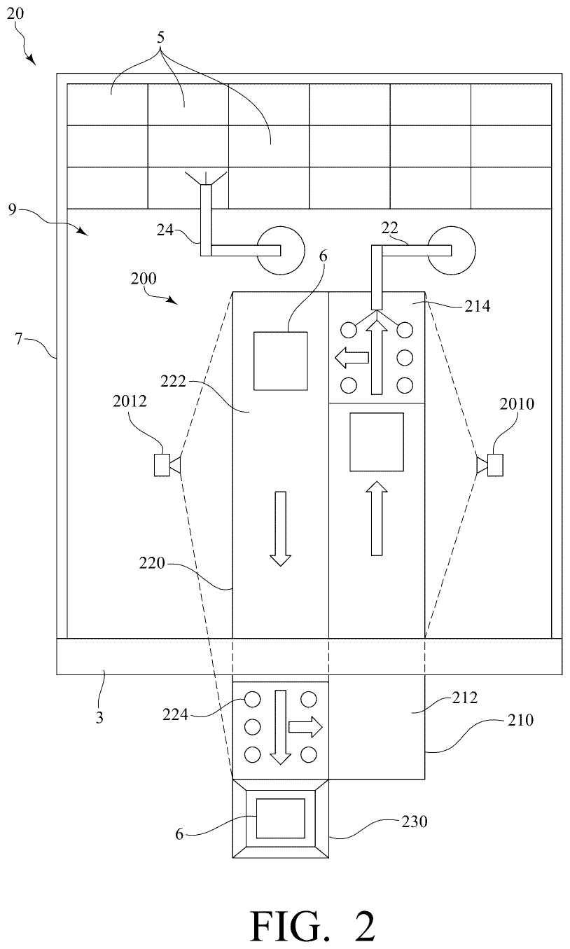

Referring now to FIGS. 2 and 10, like the parcel transfer system 10 described above with reference to FIG. 1, the parcel transfer system 20 in this exemplary embodiment also includes: an exemplary conveyor subsystem 200; a first robot 22; a second robot 24; and a control subsystem 1000 that is configured to identify unconveyable parcels and is operably connected to the conveyor subsystem 200 and the one or more robots 22, 24, such that the control subsystem 1000 can communicate instructions to control certain operations of such components. The first robot 22, the second robot 24, and the components of the control subsystem 1000 are identical in construction and provide the same functionality as the first robot 12, the second robot 14, and the control subsystem 1000, respectively, described above with reference to FIGS. 1 and 10, except as indicated otherwise.

Referring now specifically to FIG. 2, the conveyor subsystem 200 in this exemplary embodiment generally includes the same components and functions in the same manner as the conveyor subsystem 100 described above with reference to FIG. 1, except as indicated otherwise. In this regard, the conveyor subsystem 200 in this exemplary embodiment also includes a feed conveyor 210 and a rejection conveyor 220. The feed conveyor 210 is of identical construction and functions in the same manner as the feed conveyor 110 of the conveyor subsystem 100 described above with reference to FIG. 1. The rejection conveyor 220 in this exemplary embodiment, however, in addition to being configured to direct parcels off of an end of the rejection conveyor 220 into a bin 230 positioned thereby, is also configured to selectively direct parcels previously identified as “unconveyable” and offloaded from the feed conveyor 210 back onto the feed conveyor 210 for another attempt to be transferred by the first robot 22 or the second robot 24. To this end, in this exemplary embodiment, the rejection conveyor 220 actually includes two separate conveyors: a first conveyor 222, which is positioned to receive parcels from the feed conveyor 210; and a second conveyor 224 positioned to receive parcels from the first conveyor 222 of the rejection conveyor 220. In this exemplary embodiment, the first conveyor 222 of the rejection conveyor 220 is a unidirectional belt conveyor which is configured to convey parcels loaded thereon in a rearward direction along a longitudinal axis of the rejection conveyor 220 toward the second conveyor 224 of the rejection conveyor 220. In this exemplary embodiment, the second conveyor 224 of the rejection conveyor 220 is a multi-directional, activated roller conveyor consistent with that described above for the second conveyor 114 of the feed conveyor 110 of the conveyor subsystem 100 described above with reference to FIG. 1, except that the second conveyor 224 can be driven in the rearward direction to direct parcels into the bin 230 and the rollers of the second conveyor can be selectively activated to direct parcels off of the second conveyor 224 of the rejection conveyor 220 in a direction transverse to the longitudinal axis of the rejection conveyor 220 and onto the feed conveyor 210.

Referring now again to FIGS. 2 and 10, in this exemplary embodiment, the first conveyor 222 and the second conveyor 224 of the rejection conveyor 220 are each operably connected to the controller 1020 of the control subsystem 1000, such that the controller 1020 can communicate instructions (signals) which cause the first conveyor 222 to drive parcels located thereon toward the second conveyor 224 and the second conveyor 224 to drive parcels located thereon either into the bin 230 or back onto the feed conveyor 210. As shown, in this exemplary embodiment, the control subsystem 1000 includes two cameras: a first camera 2010; and a second camera 2012. The first camera 2010 functions in the same manner as the camera 1010 described above with reference to the parcel transfer system 10 of FIG. 1. The second camera 2012 is positioned to capture images of parcels on the rejection conveyor 220 and, like the first camera 2010, communicates the images to the controller 1020 to which it is operably connected for subsequent processing. Using the images received from the second camera 2012, the controller 1020 communicates instructions which cause the first conveyor 222 and the second conveyor 224 of the rejection conveyor 220 to either direct parcels on the rejection conveyor 220 into the bin 230 or back onto the feed conveyor 210. Alternative embodiments are, however, contemplated herein in which a single camera is utilized to capture the images of the feed conveyor 210 and the rejection conveyor 220 used by the controller 1020, as well as embodiments in which more than two cameras are utilized to capture the images of the feed conveyor 210 and the rejection conveyor 220 used by the controller 1020.

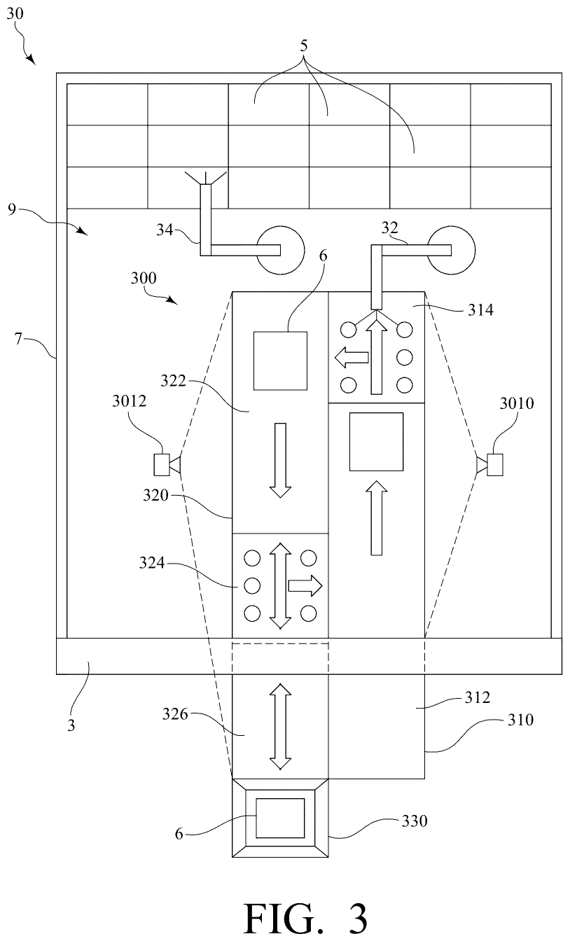

Referring now to FIGS. 3 and 10, like the parcel transfer systems 10, 20 described above with reference to FIGS. 1 and 2, the parcel transfer system 30 in this exemplary embodiment also includes: an exemplary conveyor subsystem 300; a first robot 32; a second robot 34; and a control subsystem 1000 that is configured to identify unconveyable parcels and is operably connected to the conveyor subsystem 300 and the one or more robots 32, 34, such that the control subsystem 1000 can communicate instructions to control certain operations of such components. The first robot 32, the second robot 34, and the components of the control subsystem 1000 are identical in construction and provide the same functionality as the first robots 12, 22 the second robot 14, 24, and the control subsystem 1000, respectively, described above with reference to FIGS. 1, 2, and 10, except as indicated otherwise.

Referring now specifically to FIG. 3, the conveyor subsystem 300 in this exemplary embodiment generally includes the same components and functions in the same manner as the conveyor subsystem 200 described above with reference to FIG. 2. In this regard, the conveyor subsystem 300 in this exemplary embodiment also includes a feed conveyor 310 and a rejection conveyor 320. The feed conveyor 310 is of identical construction and functions in the same manner as the feed conveyor 210 of the conveyor subsystem 200 described above with reference to FIG. 2, except as indicated otherwise. The rejection conveyor 320 includes a first conveyor 322 and a second conveyor 324 identical in construction and functionality as the first conveyor 222 and the second conveyor 224 of the conveyor subsystem 200 described above with reference to FIG. 2, except as indicated otherwise. However, in this exemplary embodiment, the rejection conveyor 320 also includes a third conveyor 326 positioned to receive parcels directed off of a distal end of the second conveyor 324 (i.e., the end closest to the third conveyor 326). In this exemplary embodiment, the third conveyor 326 is a bidirectional belt conveyor that can be selectively activated to drive parcels positioned on the third conveyor 326 either in a first direction to direct parcels off of a distal end of the third conveyor 326 and into a bin 330 positioned thereby or in a second, opposite direction to direct parcels off of a proximal end of the third conveyor 326 and back onto the second conveyor 324. In this exemplary embodiment, the belt of the second conveyor 324 can be driven in either a forward direction to move parcels toward the third conveyor 326 or a rearward direction to help facilitate transfer of parcels on the third conveyor 326 back onto the second conveyor 324.

Referring still to FIG. 3, the third conveyor 326 of the rejection conveyor 320 can be used to remove unconveyable parcels from the conveyor subsystem 300 or serve as a temporary holding area in which parcels previously identified as “unconveyable” but suitable for eventual transfer back onto the feed conveyor 310 can be held while other parcels on the rejection conveyor 320 are transferred back onto the feed conveyor 310 by the second conveyor 324 of the rejection conveyor 320. The rejection conveyor 320 arrangement in this exemplary embodiment may thus prove advantageous in instances where (i) the cargo area 9 is intended to be loaded in a specific manner necessitating the criteria as to which parcels are identified as “unconveyable” change as the cargo area 9 is loaded and (ii) it is beneficial to keep parcels which meet the unconveyable criteria at one time, but not necessarily at another, later time, in circulation within the conveyor subsystem 300. For instance, in some implementations it may be desirable to load the cargo area 9 in a manner where the parcels decrease in size as the cargo area 9 is loaded. In such implementations, smaller parcels may be held by the third conveyor 326 of the rejection conveyor 320 until all parcels of larger dimension have been transferred by the first robot 312 or the second robot 314, at which time the third conveyor 326 is activated to transfer the smaller parcels back onto the second conveyor 324 for subsequent offloading back onto the feed conveyor 310.

Referring now again to FIGS. 3 and 10, in this exemplary embodiment, the first conveyor 322, the second conveyor 324, and the third conveyor 326 of the rejection conveyor 320 are each operably connected to the controller 1020 of the control subsystem 1000. In this regard, the first conveyor 322 and the second conveyor 324 of the rejection conveyor 320 are operably connected to the controller 1020 in the same manner as the first conveyor 222 and the second conveyor 224 of the conveyor subsystem 200 described above with reference to FIG. 2. However, in this exemplary embodiment, the controller 1020 is also configured to selectively communicate instructions which drive the belt of the second conveyor 324 rearward toward the first conveyor 322 of the rejection conveyor 320. The third conveyor 326 is operably connected to the controller 1020, such that the controller 1020 can selectively communicate instructions which cause the third conveyor 326 to be driven in a forward or rearward direction. As shown, in this exemplary embodiment, the control subsystem 1000 utilizes a first camera 3010 and a second camera 3012 in the same manner as the first camera 2010 and the second camera 2012, respectively, of the parcel transfer system 20 described above with reference to FIG. 2, except that the images captured by the second camera 3012 are also used by the controller 1020 to determine when instructions (signals) should be communicated to the third conveyor 326 to drive the third conveyor 326 in either a forward or rearward direction.

Although not shown in FIG. 3, alternative embodiments in which the first conveyor 322 of the rejection conveyor 320 is a bidirectional belt conveyor to allow parcels received on the first conveyor 322 of the rejection conveyor 320 to be conveyed forward toward the second conveyor 324 of the rejection conveyor 320 or backward toward the robots 32, 34 for subsequent engagement by one of the robots 32, 34 are also contemplated herein. In such embodiments, the controller 1020 operably connected to the first conveyor 322 of the rejection conveyor 320 would selectively transmit instructions to drive the first conveyor 322 in either the forward or rearward direction based on images received from the first camera 3010 and/or the second camera 3012.

Although not shown in FIG. 3, alternative embodiments in which the first conveyor 322 of the rejection conveyor 320 is an activated roller belt multi-directional conveyor to permit parcels loaded onto the first conveyor 322 of the rejection conveyor 320 to be selectively directed off of the first conveyor 322 of the rejection conveyor 320 back onto the feed conveyor 310 are also contemplated herein. In such embodiments, the controller 1020 operably connected to the first conveyor 322 of the rejection conveyor 320 would selectively transmit instructions to selectively drive the rollers of the first conveyor 322 and direct parcels loaded thereon back onto the feed conveyor 310.

Although not shown in FIG. 3, alternative embodiments in which the feed conveyor 310 includes an additional activated roller belt multi-directional conveyor positioned upstream of the second conveyor 314 of the feed conveyor 310, as well as embodiments in which the first conveyor 312 of the feed conveyor 310 is an activated roller belt multi-directional conveyor to permit the transfer of parcels from the feed conveyor 310 to the rejection conveyor 320 at additional locations along the length of the feed conveyor 310, are contemplated herein. In such embodiments, the controller 1020 is operably connected to the additional multi-directional conveyor, or first conveyor 312 of the feed conveyor 310 would selectively transmit instructions to selectively drive the rollers of the additional multi-directional conveyor or the first conveyor 312 and direct parcels loaded thereon to the rejection conveyor 320.

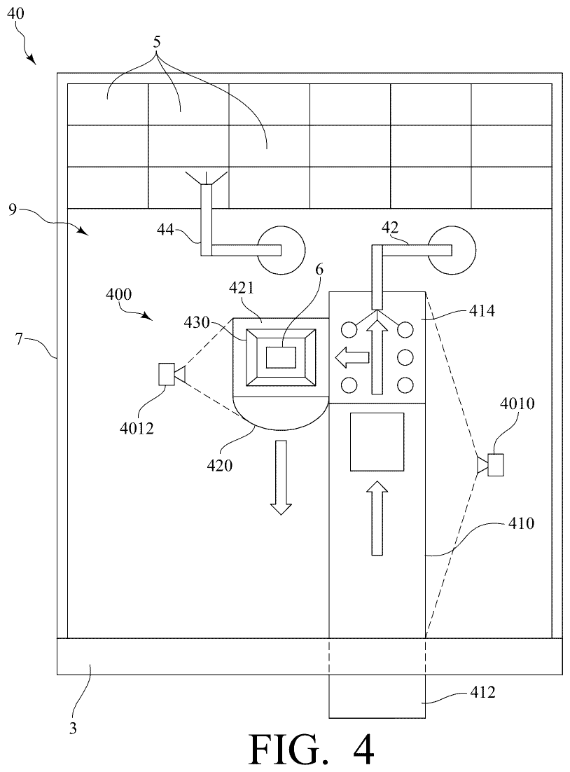

Referring now to FIGS. 4 and 10, like the parcel transfer systems 10, 20, 30 described above with reference to FIGS. 1-3, the parcel transfer system 40 in this exemplary embodiment also includes: an exemplary conveyor subsystem 400; a first robot 42; a second robot 44; and a control subsystem 1000 that is configured to identify unconveyable parcels and is operably connected to the conveyor subsystem 400 and the one or more robots 42, 44, such that the control subsystem 1000 can communicate instructions to control certain operations of such components. The first robot 42, the second robot 44, and the components of the control subsystem 1000 are identical in construction and provide the same functionality as the first robot 12, 22, 32 the second robot 14, 24, 34 and the control subsystem 1000, respectively, described above with reference to FIGS. 1-3 and 10, except as indicated otherwise.

Referring now specifically to FIG. 4, the conveyor subsystem 400 in this exemplary embodiment includes a feed conveyor 410 and a self-driving vehicle (“SDV”) 420. The feed conveyor 410 is of identical construction and functions in the same manner as the feed conveyors 110, 210, 310 of the exemplary conveyor subsystems 100, 200, 300 described above with reference to FIGS. 1-3. In this exemplary embodiment, the SDV 420 includes: a base 421; and a drive subassembly 422 (FIG. 10) that is mounted to the base 421 and includes a plurality of wheels (not shown) that can be driven to move the SDV 420 within or out of the cargo area 9. In some embodiments, the SDV 420 may include one or more components of, and may be driven by a motor control subsystem in a manner similar to, the SDV disclosed in commonly assigned U.S. Pat. No. 11,897,702, which is incorporated herein by reference.

Referring still to FIG. 4, when the parcel transfer system 40 is in use, the SDV 420 will position itself (e.g., in response to instructions (signals) received from the controller 1020 to which it is operably connected) alongside the second, multi-directional conveyor 414 of the feed conveyor 410, such that, as unconveyable parcels 6 are offloaded from the second conveyor 414 of the feed conveyor 410, they are received by the SDV 420, in this case, by a bin 430 positioned on the base 421 of the SDV 420. Once an unconveyable parcel is received by the SDV 420 or the bin 430 carried thereby is filled, the SDV 420 will transport the unconveyable parcel(s) to an intended destination, either elsewhere in the cargo area 9 or out of the cargo area 9 altogether. While only a single SDV 420 is shown in FIG. 4, in some embodiments, the conveyor subsystem 400 may include additional SDVs, so that as one SDV leaves its position alongside the second conveyor 414 of the feed conveyor 410, another SDV takes its place.

Referring now again to FIGS. 4 and 10, in this exemplary embodiment, the SDV 420 is operably connected to the controller 1020 via a network 1030 using known interfaces and protocols, such that the controller 1020 can communicate instructions (signals) which cause the SDV 420 to move. As shown in FIG. 4, in this exemplary embodiment, the control subsystem 1000 utilizes a first camera 4010 and a second camera 4012 operably connected, and configured to transmit image data, to the controller 1020. The first camera 4010 is utilized in the same manner as the first cameras 1010, 2010, 3010 of the parcel transfer systems 10, 20, 30 described above with reference to FIGS. 1-3. The second camera 4012 is positioned such that, when the SDV 420 is positioned alongside the second conveyor 414 of the feed conveyor 410, the second camera 4012 can capture images of the SDV 420 and/or the bin 430 positioned thereon for subsequent processing by the controller 1020. Based on the received image data from the second camera 4012, the controller 1020 will determine whether the SDV 420 loaded with unconveyable parcels 6 should be moved to transport the unconveyable parcels 6 to an intended destination and then subsequently communicate instructions (signals) which cause the SDV 420 to travel to the intended destination.

Alternative embodiments in which the SDV 420 includes one or more sensors configured to gather data indicative of parcel presence on the SDV 420 and/or parcel weight (e.g., an onboard scale for measuring parcel weight) and communicate such data to the controller 1020 for subsequent processing are also contemplated herein. In such embodiments, the data from the sensors of the SDV 420 may be used in addition to or as an alternative to the image data from the second camera 4012 with respect to determining whether the SDV 420 should be moved to transport unconveyable parcels to an intended destination. Accordingly, alternative embodiments of the parcel transfer system 40 in which the second camera 4012 is omitted are also contemplated herein.

With respect to FIG. 4, it should also be recognized that, once a particular parcel has been rejected and offloaded onto the SDV 420, it may then be possible to engage the parcel on the SDV 420 with one of the robots 42, 44, now that the parcel has been isolated and moved away from the parcel stack on the feed conveyor 410. Thus, in some implementations, the SDV 420 may provide part of the picking area from which the first robot 42 and/or the second robot 44 can engage and transfer parcels from.

Although not shown in FIG. 4, as a further refinement, it is contemplated that, in some alternative embodiments, the SDV 420 may include one or more conveyor belts which can be selectively activated to help facilitate the loading of parcels directed off of the feed conveyor 110 onto the SDV and/or to transfer parcels loaded onto the SDV 420 back onto the feed conveyor 410 so that the robots 42, 44 can make another attempt at engaging the parcel. In such embodiments, the controller 1020 to which the SDV 420 is operably connected would selectively transmit instructions to selectively activate the one or more conveyor belts to facilitate the loading of parcels onto or the offloading of parcels from the SDV 420. One suitable SDV which may be utilized as the SDV 420 in such embodiments is that disclosed in U.S. Pat. No. 11,897,702, which, again, is incorporated herein by reference.

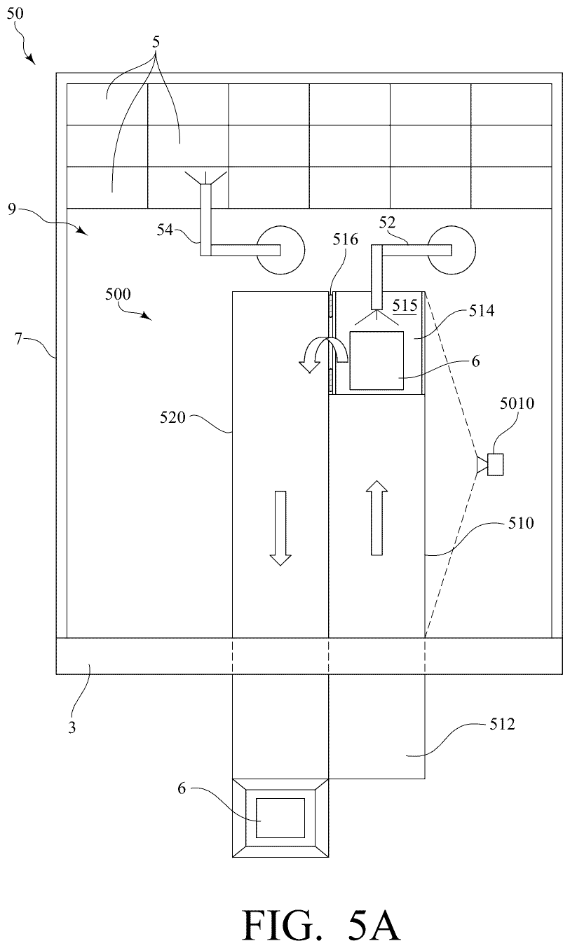

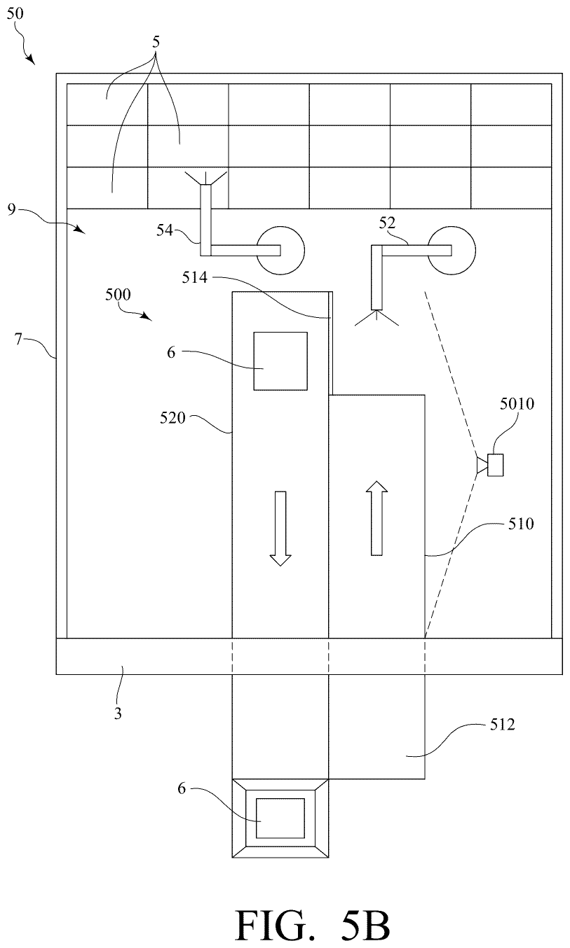

Referring now to FIGS. 5A, 5B, and 10, the parcel transfer system 50 in this exemplary embodiment is similar to the parcel transfer system 10 described above with reference to FIGS. 1-4. In this regard, the parcel transfer system 50 in this exemplary embodiment also includes: an exemplary conveyor subsystem 500; a first robot 52; a second robot 54; and a control subsystem 1000 that is configured to identify unconveyable parcels and is operably connected to the conveyor subsystem 500 and the one or more robots 52, 54, such that the control subsystem 1000 can communicate instructions to control certain operations of such components. The first robot 52, the second robot 54, and the components of the control subsystem 1000 are identical in construction and provide the same functionality as the first robot 12, 22, 32, 42, the second robot 14, 24, 34, 44, and the control subsystem 1000, respectively described above with reference to FIGS. 1-4 and 10, except as indicated otherwise.

Referring still to FIGS. 5A, 5B, and 10, the conveyor subsystem 500 in this exemplary embodiment is of the same construction as the conveyor subsystem 100 described above with reference to FIG. 1, except that the second conveyor 514 can be activated to angle its conveying surface 515 and flip or slide unconveyable parcels 6 onto the rejection conveyor 520, as evidenced by viewing FIGS. 5A and 5B in sequence. Specifically, in this exemplary embodiment, the conveying surface 515 of the second conveyor 514 of the feed conveyor 510 is mounted for rotation with respect to a frame of the second conveyor 514 of the feed conveyor 510, such that the picking area defined by the conveying surface 515 of the second conveyor 514 can be selectively transitioned between a first, lowered configuration (FIG. 5A) and a second, raised configuration (FIG. 5B). In this exemplary embodiment, the conveying surface 515 of the second conveyor 514 of the feed conveyor 510 is mounted to a frame of the second conveyor 514 by a hinge 516, and transition of the conveying surface 515 between the first, lowered configuration and the second, raised configuration is regulated by operation of an actuator 517 (FIG. 10) operably connected to the conveying surface 515.

Of course, alternative means for mounting the conveying surface 515 and/or rotating the conveying surface 515 may be employed without departing from the spirit and scope of the present invention. In this exemplary embodiment, the conveying surface 515 of the second conveyor 514 of the feed conveyor 510 is defined by a unidirectional conveyor belt. Of course, alternative devices or mechanisms which can be transitioned from a first configuration to a second configuration to flip or slide unconveyable parcels onto the rejection conveyor 520, and which can either be positioned downstream of the first conveyor 512 of the feed conveyor 510 and/or integrated with the conveying surface 515 of the second conveyor 514 may alternatively be utilized without departing from the spirit and scope of the present invention. For instance, in alternative embodiments, the conveying surface 515 of the second conveyor 514 may be defined by a surface which is not configured to be driven in either a forward direction, a rearward direction, or a direction transverse to the longitudinal axis of the feed conveyor 510 when the conveyor subsystem 500 is in use. In such embodiments, the second conveyor 514 of the feed conveyor may also be characterized as a “door.”

Referring now again to FIGS. 5A, 5B, and 10, in this exemplary embodiment, the feed conveyor 510 and the rejection conveyor 520 are operably connected to the controller 1020 of the control subsystem 1000 in the same manner as described above for the feed conveyor 110 and the rejection conveyor 120 of the conveyor subsystem 100 described above with reference to FIG. 1, except that the actuator 517 of the second conveyor 514 of the feed conveyor 510 is also operably connected to the controller 1020. In this regard, the controller 1020 can selectively communicate instructions (signals) which cause the actuator 517 of the second conveyor 514 of the feed conveyor 510 to transition the conveying surface 515 of the second conveyor 514 between the first, lowered configuration and the second, raised configuration to selectively transfer unconveyable parcels 6 onto the rejection conveyor 520. In determining which parcels are unconveyable, and thus when the actuator 517 of the second conveyor 514 should be activated, the controller 1020 utilizes images of the feed conveyor 510 acquired by a camera 5010 operably connected to the controller 1020.

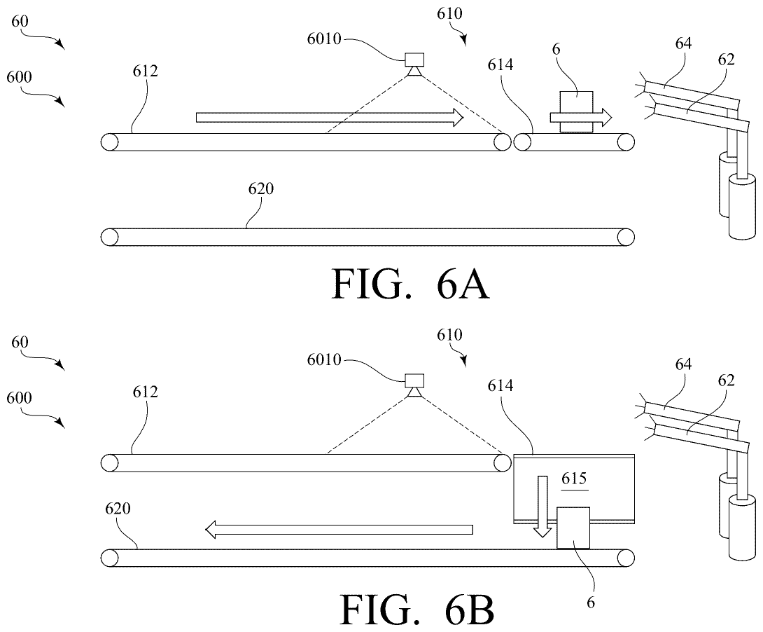

Within the parcel transfer systems 10, 20, 30, 40, 50 described above with reference to FIGS. 1-4, 5A, and 5B, the feed conveyor and the rejection conveyor or the feed conveyor and the SDV are positioned beside each other, such that the transfer of a parcel from the feed conveyor to the rejection conveyor or the SDV, or from the rejection conveyor or the SDV to the feed conveyor is achieved primarily as a result of the parcel being moved laterally off the side of the feed conveyor, or off the side of the rejection conveyor or the SDV. Indeed, in some embodiments, the conveying surfaces of the feed conveyor and the rejection conveyor or conveying surface of the feed conveyor and surface onto which parcels are received on the SDV may be positioned along a common horizontal plane. However, as evidenced below in the discussion of the parcel transfer systems 60, 70, 80, 90 described below with reference to FIGS. 6A, 6B, 7A, 7B, 8, and 9, parcels can also be handled in system arrangements in which the feed conveyor and the rejection conveyor or the SDV are not positioned beside each other.

Referring now to FIGS. 6A, 6B, and 10, in this exemplary embodiment, the parcel transfer system 60 is similar to the parcel transfer systems 10, 20, 30, 40, 50 described above with reference to FIGS. 1-4, 5A, and 5B. In this regard, the parcel transfer system 60 in this exemplary embodiment, also includes: an exemplary conveyor subsystem 600; a first robot 62; a second robot 64; and a control subsystem 1000 that is configured to identify unconveyable parcels 6 and is operably connected to the conveyor subsystem 600 and the one or more robots 62, 64, such that the control subsystem 1000 can communicate instructions to control certain operations of such components. The first robot 62, the second robot 64, and the components of the control subsystem 1000 are identical in construction and provide the same functionality as the first robot 12, 22, 32, 42, 52, the second robot 14, 24, 34, 44, 54, and the control subsystem 1000, respectively, described above with reference to FIGS. 1-4, 5A, and 5B, except as indicated otherwise.

Referring now specifically to FIGS. 6A and 6B, the conveyor subsystem 600 in this exemplary embodiment is of the same construction as the conveyor subsystem 500 described above with reference to FIGS. 5A and 5B, except that the rejection conveyor 620 is positioned beneath the feed conveyor 610 and the conveying surface 615 of the second conveyor 614 is configured to transition between a first, raised configuration (FIG. 6A) and a second, lowered configuration (FIG. 6B) to drop unconveyable parcels 6 onto the rejection conveyor 620.

Referring now again to FIGS. 6A, 6B, and 10, in this exemplary embodiment, the feed conveyor 610 and the rejection conveyor 620 are operably connected to the controller 1020 of the control subsystem 1000 in similar fashion as described above for the feed conveyor 510 and the rejection conveyor 520 of the conveyor subsystem 500 described above with reference to FIGS. 5A and 5B. In this regard, the controller 1020 can selectively communicate instructions (signals) to an actuator 617 of the second conveyor 614 of the feed conveyor 610 to transition the conveying surface 615 of the second conveyor 614 between the first, raised configuration and the second, lowered configuration to selectively drop unconveyable parcels 6 onto the rejection conveyor 620. In determining which parcels are unconveyable, and thus when the actuator 617 (FIG. 10) of the second conveyor 614 should be activated to transition or allow the second conveyor 614 to transition to the second, lowered configuration, the controller 1020 utilizes images of the feed conveyor 610 and parcels located thereon acquired by a camera 6010 operably connected to the controller 1020.

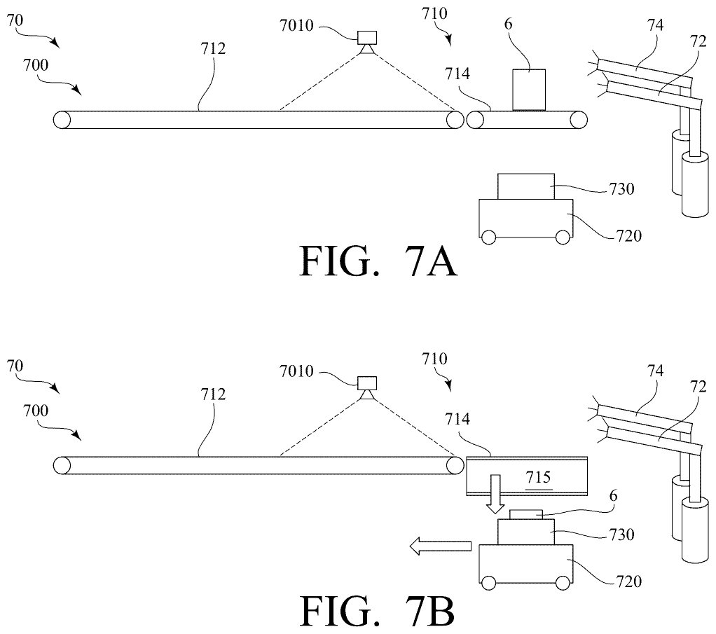

Referring now to FIGS. 7A, 7B, and 10, in this exemplary embodiment, the parcel transfer system 70 is similar to the parcel transfer systems 10, 20, 30, 40, 50, 60 described above with reference to FIGS. 1-4, 5A, 5B, 6A, and 6B. In this regard, the parcel transfer system 70 in this exemplary embodiment, also includes: an exemplary conveyor subsystem 700; a first robot 72; a second robot 74; and a control subsystem 1000 that is configured to identify unconveyable parcels and is operably connected to the conveyor subsystem 700 and the one or more robots 72, 74, such that the control subsystem 1000 can communicate instructions to control certain operations of such components. The first robot 72, the second robot 74, and the components of the control subsystem 1000 are identical in construction and provide the same functionality as the first robot 12, 22, 32, 42, 52, 62, the second robot 14, 24, 34, 44, 54, 64, and the control subsystem 1000, respectively, described above with reference to FIGS. 1-4, 5A, 5B, 6A, 6B, and 10, except as indicated otherwise.

Referring now specifically to FIGS. 7A and 7B, the conveyor subsystem 700 in this exemplary embodiment is of the same construction as the conveyor subsystem 600 described above with reference to FIGS. 6A and 6B, except that, instead of a rejection conveyor, a SDV 720 is utilized to handle unconveyable parcels 6 offloaded from the second conveyor 714 of the feed conveyor 710. The SDV 720 in this exemplary embodiment is of the same construction and provides the same functionality as the SDV 420 of the conveyor subsystem 400 described above with reference to FIG. 4.

Referring now again to FIGS. 7A, 7B, and 10, in this exemplary embodiment, the feed conveyor 710 is operably connected to the controller 1020 of the control subsystem 1000 in the same manner as described above for the feed conveyor 610 of the conveyor subsystem 600 described above with reference to FIGS. 6A and 6B. In this regard, the controller 1020 can selectively communicate instructions (signals) to the actuator 717 of the second conveyor 714 of the feed conveyor 710 to transition the conveying surface 715 of the second conveyor 714 between the first, raised configuration (FIG. 7A) and the second, lowered configuration (FIG. 7B) to selectively drop unconveyable parcels 6 onto the SDV 720 or into a bin 730 carried by the SDV 720. In determining which parcels are unconveyable and thus when the actuator 717 of the second conveyor 714 should be activated to transition or allow the second conveyor 714 to transition to the second, lowered configuration, the controller 1020 utilizes images of the feed conveyor 710 and parcels located thereon acquired by a camera 7010 operably connected to the controller 1020. The SDV 720 is operably connected to the controller 1020 in the same manner as the SDV 420 of the conveyor subsystem 400 described above with reference to FIG. 4.

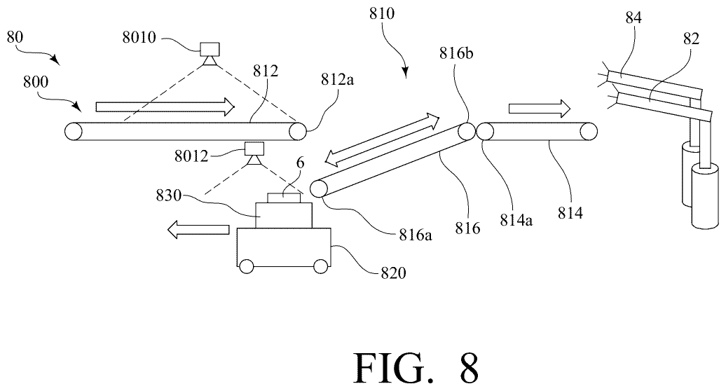

Referring now to FIGS. 8 and 10, in this exemplary embodiment, the parcel transfer system 80 includes: an exemplary conveyor subsystem 800; a first robot 82; a second robot 84; and a control subsystem 1000 that is configured to identify unconveyable parcels 6 and is operably connected to the conveyor subsystem 800 and the one or more robots 82, 84, such that the control subsystem 1000 can communicate instructions to control certain operations of such components. The first robot 82, the second robot 84, and the components of the control subsystem 1000 are identical in construction and provide the same functionality as the first robot 12, 22, 32, 42, 52, 62, 72 the second robot 14, 24, 34, 44, 54, 64, 74, and the control subsystem 1000, respectively, described above with reference to FIGS. 1-4, 5A, 5B, 6A, 6B, 7, and 10, except as indicated otherwise.

Referring now specifically to FIG. 8, the conveyor subsystem 800 in this exemplary embodiment is similar to the conveyor subsystem 400 of the parcel transfer system 40 described above with reference to FIG. 4 in that this conveyor subsystem 800 also includes a feed conveyor 810 and a SDV 820 that is configured to receive unconveyable parcels 6 offloaded from the feed conveyor 810, and which can be driven to move within or out of the cargo area 9. In this exemplary embodiment, the SDV 820 is of identical construction and provides the same functionality as the SDV 420 of the conveyor subsystem 400 described above with reference to FIG. 4. The feed conveyor 810 is of similar construction as the feed conveyors 110, 210, 310, 410 of the parcel transfer systems 10, 20, 30, 40 described above with reference to FIGS. 1-4 and, as such, includes a first conveyor 812 onto which parcels are initially loaded onto the conveyor subsystem 800 and a second conveyor 814 that is positioned downstream of the first conveyor 812 and defines a picking area of the feed conveyor 810 from which the first robot 82 and the second robot 84 can engage and transfer parcels from. However, in this exemplary embodiment, the second conveyor 814 is a unidirectional conveyor and the feed conveyor 810 further includes a third conveyor 816, which is positioned between the first conveyor 812 and the second conveyor 814.

Referring still to FIG. 8, as shown, the third conveyor 816 is, in this exemplary embodiment, positioned at an angle relative to the first conveyor 812 and the second conveyor 814 of the feed conveyor 810, such that a proximal end 816a of the third conveyor 816 is positioned lower than a distal end 812a of the first conveyor 812, and a distal end 816b of the third conveyor 816 is positioned adjacent to the proximal end 814a of the second conveyor 814. Accordingly, the third conveyor 816 in this exemplary embodiment, may be characterized as being in an “inclining” orientation. In this exemplary embodiment, the third conveyor 816 is a bidirectional belt conveyor which can be selectively activated to drive parcels offloaded from the first conveyor 812 either toward the proximal end 816a or the distal end 816b of the third conveyor 816. When the parcel transfer system 80 is in use, the SDV 820 will position itself (e.g., in response to instructions (signals) received from the controller 1020 to which it is operably connected) below a proximal end 816a of the third conveyor 816. Parcels identified as “unconveyable,” after being offloaded onto the third conveyor 816 are driven off of the proximal end 816a of the third conveyor 816 and either onto the SDV 820 or into a bin 830 provided on the SDV 820. Conversely, parcels not identified as “unconveyable,” after being offloaded onto the third conveyor 816 are driven off the distal end 816b of the third conveyor 816 and onto the second conveyor 814, where the parcels are subsequently transferred by the first robot 82 or the second robot 84.

Referring now again to FIGS. 8 and 10, in this exemplary embodiment, the third conveyor 816 is operably connected to the controller 1020, such that the controller can selectively communicate instructions (signals) which cause the third conveyor 816 to drive parcels located thereon toward the second conveyor 814 or toward the SDV 820. The SDV 820 is operably connected to the controller 1020 via a network 1030 using known interfaces and protocols, such that the controller 1020 can communicate instructions (signals) which cause the SDV 820 to move. As shown in FIG. 8, in this exemplary embodiment, the control subsystem 1000 utilizes a first camera 8010 and a second camera 8012, each of which is operably connected, and configured to transmit image data, to the controller 1020. The first camera 8010 is utilized to provide image data to the controller 1020 in the same manner as the first cameras 1010, 2010, 3010, 4010, 5010, 6010, 7010 of the parcel transfer systems 10, 20, 30, 40, 50, 60, 70 described above with reference to FIGS. 1-4, 5A, 5B, 6A, 6B, 7A, and 7B. Based on the image data received from the first camera 8010, the controller 1020 will selectively communicate instructions which cause the third conveyor 816 to drive parcels located thereon toward the second conveyor 814 or the SDV 820. The second camera 8012 is positioned so that, when the SDV 820 is positioned to receive parcels from the third conveyor 816 of the feed conveyor 810, the second camera 8012 can capture images of the SDV 820 and/or the bin 830 positioned thereon, which are subsequently communicated to and processed by the controller 1020. Based on the received image data, the controller 1020 will determine whether the SDV 820 loaded with unconveyable parcels 6 should be moved to transport the unconveyable parcels 6 to an intended destination and then subsequently communicate instructions (signals) which cause the SDV 820 to travel to the intended destination.

Alternative embodiments in which the SDV 820 includes one or more sensors configured to gather data indicative of parcel presence on the SDV 820 and/or parcel weight (e.g., an onboard scale for measuring parcel weight) and communicate such data to the controller 1020 for subsequent processing are also contemplated herein. In such embodiments, the data from the sensors of the SDV 820 may be used in addition to or as an alternative to the image data from the second camera 8012 with respect to determining whether the SDV 820 should be moved to transport unconveyable parcels to an intended destination. Accordingly, alternative embodiments of the parcel transfer system 80 in which the second camera 8012 is omitted are also contemplated herein. While only a single SDV 820 is shown in FIG. 8, in some embodiments, the conveyor subsystem 800 may include additional SDVs so that as one SDV leaves the position for receiving parcels from the third conveyor 816 of the feed conveyor 810 another SDV takes its place.

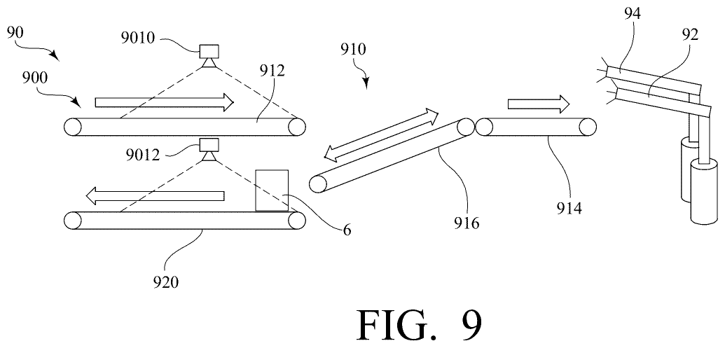

Referring now to FIG. 9, in this exemplary embodiment, the parcel transfer system 90 is of similar construction to the parcel transfer systems 10, 20, 30, 40, 50, 60, 70, 80 described above with reference to FIGS. 1-4, 5A, 5B, 6A, 6B, 7A, 7B, and 8, and, as such, includes: an exemplary conveyor subsystem 900; a first robot 92; a second robot 94; and a control subsystem 1000 that is configured to identify unconveyable parcels and is operably connected to the conveyor subsystem 900 and the one or more robots 92, 94, such that the control subsystem 1000 can communicate instructions to control certain operations of such components. The first robot 92, the second robot 94, and the components of the control subsystem 1000 are identical in construction and provide the same functionality as the first robot 12, 22, 32, 42, 52, 62, 72, 82 the second robot 14, 24, 34, 44, 54, 64, 74, 84, and the control subsystem 1000, respectively, described above with reference to FIGS. 1-4, 5A, 5B, 6A, 6B, 7A, 7B, 8, and 10, except as indicated otherwise.

Referring now specifically to FIG. 9, the conveyor subsystem 900 in this exemplary embodiment is similar to the conveyor subsystem 800 of the parcel transfer system 80 described above with reference to FIG. 8, and, as such, includes: a feed conveyor 910 comprised of a first conveyor 912, a second conveyor 914, and a third conveyor 916. However, unlike the conveyor subsystem 800 described above with reference to FIG. 8, in this exemplary embodiment, a rejection conveyor 920 is positioned below the proximal end of the third conveyor 916 instead of a SDV. In this exemplary embodiment, the rejection conveyor 920 is of identical construction and functions in the same manner as the rejection conveyor 120 of the parcel transfer system 10 described with respect to FIG. 1.

Referring now to FIGS. 9 and 10, in this exemplary embodiment, the feed conveyor 910 is operably connected to the controller 1020, and the controller 1020 utilizes image data acquired by a first camera 9010 of the control subsystem 1000 to regulate operation of the feed conveyor 910 in the same manner as the parcel transfer system 80 described above with reference to FIG. 8. In this exemplary embodiment, the control subsystem 1000 includes a second camera 9012 that is operably connected to the controller 1020 and is configured and positioned to acquire images of the rejection conveyor 920. The controller 1020 is operably connected to the rejection conveyor 920, such that the controller 1020 can selectively communicate instructions (signals) which cause the rejection conveyor 920 to drive unconveyable parcels loaded thereon to an intended destination. Alternative embodiments in which the rejection conveyor 920 is continuously driven are also contemplated herein. In such embodiments, only camera(s) for capturing images of the feed conveyor 910 would be needed.

Although the parcel transfer systems 60, 70, 80, 90 described above with reference to FIGS. 6A, 6B, 7A, 7B, 8, and 9 are not illustrated as being provided in the cargo area 9 of a transport vehicle as the parcel transfer systems 10, 20, 30, 40, 50 of FIGS. 1-4, 5A, and 5B are, one of ordinary skill in the art will readily appreciate that the parcel transfer systems 60, 70, 80, 90 described above with reference to FIGS. 6A, 6B, 7A, 7B, 8, and 9 can be similarly utilized to facilitate the loading of a parcels into a cargo area of a transport vehicle.

Although the conveyor subsystems 100, 200, 300, 400, 500, 600, 700, 800, 900 are primarily described herein in the context of being utilized to load parcels into a transport vehicle, it should be a appreciated that the utility of the conveyor subsystems 100, 200, 300, 400, 500, 600, 700, 800, 900 is not necessarily limited to such application. Rather, the conveyor subsystems 100, 200, 300, 400, 500, 600, 700, 800, 900 may find utility in a variety of sorting applications requiring parcels with certain characteristics to be separated or removed, at least temporarily, from other parcels with different characteristics.

Although the means of detecting parcels by the control subsystem 1000 is often referred to herein as being one or more cameras, it should be appreciated that the control subsystem 1000 is not so limited. Rather, the means for detecting parcels in the conveyor subsystems 100, 200, 300, 400, 500, 600, 700, 800, 900 disclosed herein may vary depending on what characteristics of a parcel make it difficult for the one or more robots to transfer such parcel and/or render the parcel undesirable for transfer at a particular time. Accordingly, such characteristics may vary depending on, for example, the type of robots utilized, the environment in which the parcel transfer system 10, 20, 30, 40, 50, 60, 70, 80, 90 is operating, and/or the desired manner in which the cargo area 9 is intended to be loaded. Accordingly, embodiments and implementations in which the control subsystem 1000 utilizes additional or alternative means of detecting parcels in the conveyor subsystems 100, 200, 300, 400, 500, 600, 700, 800, 900 are also contemplated herein. For instance, in some embodiments and implementations where the criteria for identifying a parcel “unconveyable” relates to the weight of the parcel, the control subsystem 1000 may additionally or alternatively include a scale. In one such embodiment and implementation, the scale may be integrated into the feed conveyor 110, 210, 310, 410, 510, 610, 710, 810, 910 of the conveyor subsystem 100, 200, 300, 400, 500, 600, 700, 800, 900.

Furthermore, while certain conveyors of the various conveyor subsystems 100, 200, 300, 400, 500, 600, 700, 800, 900 described herein are sometimes referred to as belt conveyors, it is appreciated that alternative conveyor types (e.g., roller conveyors) suitable for carrying out the functionalities provided by such conveyors may alternatively be utilized without departing from the spirit and scope of the present invention. Additionally, although the certain conveyors, or specific components of certain conveyors, of the various conveyor subsystems 100, 200, 300, 400, 500, 600, 700, 800, 900 are described herein as being unidirectional, alternative embodiments in which such conveyors, or specific components of certain conveyors, are instead bidirectional are also contemplated herein, except as otherwise indicated or where context precludes. In some embodiments, the feed conveyors 110, 210, 310, 410, 510, 610, 710, 810, 910 or certain portions thereof and/or the rejection conveyors 120, 220, 320, 520, 620, 720, 920 or certain portions thereof may define or be part of an extendible conveyor with a plurality of conveying sections which are configured to transition between a retracted configuration and an extended configuration, with each conveying section having a conveying surface defined by, for example, a belt operated by a roller arrangement. Suitable extendible conveyors which may be utilized in the conveyor subsystem 100 include those disclosed in U.S. Pat. Nos. 10,654,652 and 10,926,958, each of which is incorporated herein by reference.

It should also be appreciated that, while the use of multiple robots is generally preferred within the parcel transfer systems 10, 20, 30, 40, 50, 60, 70,80, 90 disclosed herein, it is not required as the benefits and advantages provided by the disclosed conveyor subsystems 100, 200, 300, 400, 500, 600, 700, 800, 900 will also be realized in single-robot system arrangements. Accordingly, alternative embodiments in which the parcel transfer system 10, 20, 30, 40, 50, 60, 70, 80, 90 disclosed herein include only a single robot for transferring parcels from the conveyor subsystem 100, 200, 300, 400, 500, 600, 700, 800, 900 to the cargo area 9 are also contemplated herein.

It is appreciated that each operation performed by the exemplary parcel transfer systems 10, 20, 30, 40, 50, 60, 70, 80, 90 described herein can also be characterized as a method step, unless otherwise specified or context precludes. For instance, in view of the system operations described above, it should be appreciated that the present disclosure contemplates an exemplary method for loading parcels into a cargo area of a transport vehicle that includes (i) one or more robots for transferring parcels from one location to another, (ii) a conveyor subsystem including a feed conveyor and rejection apparatus (e.g., a rejection conveyor or SDV), and (iii) a control subsystem configured to obtain and process data corresponding to one or more characteristics of parcels positioned, at least partially, within the cargo area of the transport vehicle, comprises steps of (a) conveying a flow of parcels toward the one or more robots via the feed conveyor; (b) transferring, by the one or more robots, parcels in the flow of parcels from the feed conveyor to the cargo area; and (c) directing select parcels in the flow of parcels from the feed conveyor to the rejection apparatus based on the data obtained and processed by the control subsystem. Different embodiments of the one or more robots, conveyor subsystems, and/or the control subsystems disclosed in connection with the various parcel transfer systems described above can be utilized in various implementations of the foregoing method.

One of ordinary skill in the art will recognize that additional embodiments and implementations are also possible without departing from the teachings of the present invention. This detailed description, and particularly the specific details of the exemplary embodiments and implementations disclosed herein, are given primarily for clarity of understanding, and no unnecessary limitations are to be understood therefrom, for modifications will become obvious to those skilled in the art upon reading this disclosure and may be made without departing from the spirit or scope of the invention.

Of particular note, it should be appreciated that one or more components of one exemplary parcel transfer system described herein may be integrated into, or used to substitute certain components of, another exemplary parcel transfer system described herein to establish yet another exemplary parcel transfer system. Further, it should also be appreciated that one or more components of the exemplary conveyor subsystems described herein may be integrated into, or used to substitute certain components of, another exemplary conveyor subsystem described herein to establish yet another exemplary conveyor subsystem. For instance, in an alternative embodiment, a parcel transfer system may include a conveyor subsystem which includes both a rejection conveyor and a SDV without departing from the spirit and scope of the present invention.

What is claimed is:

1. A conveyor subsystem for a parcel transfer system including one or more robots for transferring parcels, the conveyor subsystem comprising:
a feed conveyor configured to convey a flow of parcels toward the one or more robots of the parcel transfer system, and to selectively direct select parcels from the flow of parcels off of the feed conveyor; and
a rejection conveyor positioned to receive the select parcels directed off of the feed conveyor, and configured to direct the select parcels off of the rejection conveyor.

2. The conveyor subsystem as recited in claim 1, wherein the feed conveyor includes
a first conveyor configured to convey the flow of parcels in at least a first direction along a longitudinal axis of the feed conveyor toward the one or more robots of the parcel transfer system, and
a second conveyor positioned downstream of the first conveyor and configured to convey the flow of parcels in the first direction along the longitudinal axis of the feed conveyor and convey the select parcels in a second direction transverse to the longitudinal axis of the feed conveyor to direct the select parcels off of the feed conveyor.

3. The conveyor subsystem as recited in claim 2, wherein the rejection conveyor is positioned beside the feed conveyor, such that the longitudinal axis of the feed conveyor and a longitudinal axis of the rejection conveyor are parallel to each other.

4. The conveyor subsystem as recited in claim 2, wherein the second conveyor of the feed conveyor is an activated roller belt.

5. The conveyor subsystem as recited in claim 1, wherein the rejection conveyor includes a multi-directional conveyor configured to convey the select parcels received by the rejection conveyor in a first direction along a longitudinal axis of the rejection conveyor and convey the select parcels in a second direction transverse to the longitudinal axis of the rejection conveyor to direct the select parcels received by the rejection conveyor back to the feed conveyor.

6. The conveyor subsystem as recited in claim 1, wherein the rejection conveyor includes:
a first conveyor positioned to receive the select parcels directed off of the feed conveyor, and configured to convey the select parcels in a first direction along a longitudinal axis of the rejection conveyor;
a second conveyor positioned to receive the select parcels from the first conveyor and configured to convey the select parcels received from the first conveyor in (i) the first direction along the longitudinal axis of the rejection conveyor, (ii) a second direction along the longitudinal axis of the rejection conveyor opposite of the first direction, and (iii) a third direction transverse to the longitudinal axis of the rejection conveyor; and
a third conveyor positioned to receive parcels from the select parcels directed off the second conveyor in the first direction, and configured to selectively convey the parcels from the select parcels received from the second conveyor in (i) the first direction along the longitudinal axis of the rejection conveyor to direct the select parcels received from the second conveyor off of the rejection conveyor and (ii) the second direction to direct the parcels from the select parcels received from the second conveyor back onto the second conveyor.

7. The conveyor subsystem as recited in claim 1, wherein the feed conveyor includes:
a first conveyor configured to convey the flow of parcels in at least a first direction along a longitudinal axis of the feed conveyor toward the one or more robots of the parcel transfer system; and
a second conveyor positioned to receive the flow of parcels from the first conveyor, the second conveyor including a repositionable surface configured to selectively transition between a first configuration and a second configuration to direct parcels off of the feed conveyor.

8. The conveyor subsystem as recited in claim 7,
wherein the repositionable surface of the second conveyor of the feed conveyor is, when in the second configuration, raised relative to when the repositionable surface is in the first configuration; and
wherein the rejection conveyor is positioned relative to the feed conveyor, such that, the repositionable surface of the feed conveyor can selectively be transitioned from the first configuration to the second configuration to direct the select parcels from the flow of parcels onto the rejection conveyor.

9. The conveyor subsystem as recited in claim 7,
wherein the repositionable surface of the second conveyor is, when in the second configuration, lowered relative to when the repositionable surface is in the first configuration; and
wherein the rejection conveyor is positioned relative to the feed conveyor, such that, the repositionable surface of the feed conveyor can selectively be transitioned from the first configuration to the second configuration to drop the select parcels from the flow of parcels onto the rejection conveyor.

10. The conveyor subsystem as recited in claim 1, wherein the feed conveyor includes:
a first conveyor configured to convey the flow of parcels in at least a first direction along a longitudinal axis of the feed conveyor toward the one or more robots of the parcel transfer system;
a second conveyor positioned downstream of the first conveyor and configured to receive parcels from the flow of parcels; and
a third conveyor positioned between the first conveyor and the second conveyor, such that (i) a portion of the third conveyor is positioned below a distal end of the first conveyor, and (ii) a distal end of the third conveyor is positioned relative to the second conveyor, such that parcels directed off the distal end of the third conveyor are received by the second conveyor;
wherein the third conveyor is configured to selectively convey parcels from the flow of parcels toward the second conveyor or the rejection conveyor.

11. A conveyor subsystem for a parcel transfer system including one or more robots for transferring parcels, the conveyor subsystem comprising:
a feed conveyor configured to convey a flow of parcels toward the one or more robots of the parcel transfer system, and to selectively direct select parcels from the flow of parcels off of the feed conveyor; and
a self-driving vehicle positioned to receive the select parcels directed off of the feed conveyor.

12. The conveyor subsystem as recited in claim 11, wherein the feed conveyor includes:
a first conveyor configured to convey the flow of parcels in at least a first direction along a longitudinal axis of the feed conveyor toward the one or more robots of the parcel transfer system; and
a second conveyor positioned downstream of the first conveyor and configured to convey the flow of parcels in the first direction along the longitudinal axis of the feed conveyor and convey the select parcels in a second direction transverse to the longitudinal axis of the feed conveyor to direct the select parcels off of the feed conveyor.

13. The conveyor subsystem as recited in claim 11, wherein the feed conveyor includes:
a first conveyor configured to convey the flow of parcels in at least a first direction along a longitudinal axis of the feed conveyor toward the one or more robots of the parcel transfer system; and
a second conveyor positioned to receive the flow of parcels from the first conveyor, the second conveyor including a repositionable surface configured to selectively transition between a first configuration and a second configuration to direct the select parcels onto the self-driving vehicle.

14. The conveyor subsystem as recited in claim 11, wherein the feed conveyor includes:
a first conveyor configured to convey the flow of parcels in at least a first direction along a longitudinal axis of the feed conveyor toward the one or more robots of the parcel transfer system;
a second conveyor positioned downstream of the first conveyor and configured to receive parcels from the flow of parcels; and
a third conveyor positioned between the first conveyor and the second conveyor, such that (i) a portion of the third conveyor is positioned below a distal end of the first conveyor, and (ii) a distal end of the third conveyor is positioned relative to the second conveyor, such that parcels directed off of the distal end of the third conveyor are received by the second conveyor;
wherein the third conveyor is configured to selectively convey parcels from the flow of parcels toward the second conveyor or the self-driving vehicle.

15. A parcel transfer system for loading parcels into a cargo area of a transport vehicle, comprising:
one or more robots configured to transfer parcels from the parcel transfer system to the cargo area of the transport vehicle;
a conveyor subsystem, including
a feed conveyor configured to convey a flow of parcels toward the one or more robots, and to selectively direct select parcels from the flow of parcels off of the feed conveyor, and
a rejection conveyor positioned to receive the select parcels directed off of the feed conveyor, and configured to direct the select parcels off of the rejection conveyor; and
a control subsystem operably connected to the feed conveyor, the control subsystem including
one or more sensors for acquiring data corresponding to one or more characteristics of parcels in the flow of parcels on the feed conveyor, and
a controller operably connected to the one or more sensors, the controller including a processor for executing instructions stored in a memory component to (i) receive and process the data corresponding to the one or more characteristics of parcels in the flow of parcels on the feed conveyor, and (ii) selectively communicate instructions to the feed conveyor which cause the feed conveyor to direct the select parcels from the flow of parcels off of the feed conveyor based on the data corresponding to the one or more characteristics of parcels in the flow of parcels on the feed conveyor.

16. The parcel transfer system as recited in claim 15,
wherein the control subsystem is operably connected to the one or more robots; and
wherein the memory component includes instructions, which, when executed by the processor, cause the controller to selectively communicate instructions which cause the one or more robots to engage and transfer parcels from the conveyor subsystem to the cargo area of the transport vehicle based on the data corresponding to the one or more characteristics of parcels in the flow of parcels on the feed conveyor.

17. The parcel transfer system as recited in claim 15,
wherein the control subsystem is operably connected to the rejection conveyor; and
wherein the memory component includes instructions, which, when executed by the processor, cause the controller to communicate instructions which causes the rejection conveyor to convey the select parcels to the feed conveyor or out of the conveyor subsystem.

18. The parcel transfer system as recited in claim 15, wherein the one or more sensors of the control subsystem includes a camera for acquiring one or more images of at least a portion of the feed conveyor and any parcels located thereon.

19. The parcel transfer system as recited in claim 15,
wherein the control subsystem further includes one or more sensors for acquiring data corresponding to one or more characteristics of the select parcels on the rejection conveyor;
wherein the control subsystem is operably connected to the rejection conveyor; and
wherein the memory component includes instructions, which, when executed by the processor, cause the controller of the control subsystem to (iii) receive and process the data corresponding to the one or more characteristics of the select parcels on the rejection conveyor, and (iv) selectively communicate instructions to the rejection conveyor which cause the rejection conveyor to direct the select parcels off of the rejection conveyor based on the data corresponding to the one or more characteristics of the select parcels on the rejection conveyor.

20. The parcel transfer system as recited in claim 19, wherein the one or more sensors for acquiring data corresponding to the one or more characteristics of the select parcels on the rejection conveyor includes a camera for acquiring one or more images of at least a portion of the rejection conveyor and any parcels located thereon.

21. A parcel transfer system for loading parcels into a cargo area of a transport vehicle, comprising:
one or more robots configured to transfer parcels from the parcel transfer system to the cargo area of the transport vehicle;
a conveyor subsystem, including
a feed conveyor configured to convey a flow of parcels toward the one or more robots and to selectively direct select parcels from the flow of parcels off of the feed conveyor, and
a self-driving vehicle positioned to receive the select parcels from the flow of parcels directed off of the feed conveyor; and
a control subsystem operably connected to the feed conveyor, the control subsystem including
one or more sensors for acquiring data corresponding to one or more characteristics of parcels in the flow of parcels on the feed conveyor, and
a controller operably connected to the one or more sensors, the controller including a processor for executing instructions stored in a memory component to (i) receive and process the data corresponding to one or more characteristics of the parcels in the flow of parcels on the feed conveyor, and (ii) selectively communicate instructions to the feed conveyor which cause the feed conveyor to direct the select parcels of the flow of parcels off of the feed conveyor based on the data corresponding to the one or more characteristics of parcels in the flow of parcels on the feed conveyor.

22. The parcel transfer system as recited in claim 21,
wherein the control subsystem is operably connected to the self-driving vehicle; and
wherein the memory component includes instructions, which, when executed by the processor, cause the controller to communicate instructions which cause the self-driving vehicle to transport the select parcels.

23. The parcel transfer system according to claim 21, wherein the one or more sensors of the control subsystem includes a camera for acquiring one or more images of at least a portion of the feed conveyor and any parcels located thereon.

24. The parcel transfer system according to claim 21,
wherein the control subsystem further includes one or more sensors for acquiring data corresponding to one or more characteristics of the select parcels received by the self-driving vehicle;
wherein the control subsystem is operably connected to the self-driving vehicle; and
wherein the memory component includes instructions, which, when executed by the processor, cause the controller of the control subsystem to (iii) receive and process the data corresponding to the one or more characteristics of the select parcels received by the self-driving vehicle, and (iv) selectively communicate instructions which causes the self-driving vehicle to transport the select parcels to an intended destination based on the data corresponding to the one or more characteristics of the select parcels received by the self-driving vehicle from the feed conveyor.

25. The parcel transfer system as recited in claim 24, wherein the one or more sensors for acquiring data corresponding to the one or more characteristics of the select parcels received by the self-driving vehicle from the feed conveyor includes a camera for acquiring one or more images of at least a portion of the self-driving vehicle and any parcels located thereon.
